(19) United States
(12) Patent Application Publication
(10) Pub. No.: US 2012/0314882 A1
(43) Pub. Date: Dec. 13, 2012

(54) PRODUCTION OF AMBIENT NOISE-CANCELLING EARPHONES

(75) Inventor: Alastair Sibbald, Cookham Dean (GB)

(73) Assignee: INCUS LABORATORIES LIMITED, Stokenchurch, Buckinghamshire (GB)

(21) Appl. No.: 13/510,177

(22) PCT Filed: Nov. 17, 2010
(86) PCT No.: PCT/GB10/02108

§ 371 Date: May 16, 2012

(30) Foreign Application Priority Data
Nov. 23, 2009 (GB) 0920403.3
Oct. 5, 2010 (GB) 1016722.9

(51) Int. Cl. G10K 11/16; H04R 31/00

(52) U.S. Cl. 381/71.6; 29/896.2

(57) ABSTRACT

The invention is intended to facilitate the production of ambient noise- cancelling earphones and, to that end, provides a module (30) comprising a microspeaker (34) and an electret microphone (38) both carried on a common substrate (32) which is also configured to incorporate an acoustic resistor (33, 35). The module (30) is incorporated into an earpiece having electrical connections to noise-cancelling electronic circuitry that is provided separately from the earpiece and is housed, for example, in a separate pod (82, 102) or incorporated within the body of a cellular telephone. The performances of the microspeaker (34) and microphone (38) are classified against one or more predetermined operational criteria, enabling the noise-cancelling circuitry to be configured to allow for departures from such criteria. In some embodiments, the module (30) further comprises an information storage device (40) capable of recording data concerning departures from the aforementioned criteria and of providing, upon interrogation, information over the electrical connection to automatically compensate for such departures. The invention also comprises a method of producing ambient noise-cancelling earphones in which the components on the module (30) are classified inter alia by feeding known signals to the microphone (38) and noting the response of the speaker (34) thereto.

The present invention relates to the production of ambient noise-cancelling (ANC) earphones; especially, though not exclusively, ANC earphones incorporating “ear-bud” type thin rubber flanges that seal an outlet conduit of the earphone into the entrance of the listener's ear-canal. Such earphones are sometimes referred to as “in-ear” earphones, or “ear-bud type” earphones, and these are now widely used for portable communications and entertainment applications and used, for example, whilst the listener is travelling.

It will be appreciated, in this context, that ANC is a term of art, and its use herein is not intended to imply that perfect or total cancellation of ambient noise is achieved; merely that ambient noise as perceived by a listener can be significantly reduced.

Typical applications for ANC earphones include listening to music and, in conjunction with cellular telephone handsets, for hands-free calls and conversations. In this latter example, a single earphone alone might be used, in conjunction with a microphone located on the earphone cable, near the mouth of the listener. However, it is more common to use a pair of earphones (and similar, single-microphone arrangement), because this allows the user to listen to stereophonic music and other audio material that may be stored in a music player application on the cellular phone. Earphone arrangements which include a mouth-proximal microphone for cellular communications in this manner are commonly termed “headsets”.

Although the thin rubber ear-bud flanges employed by “in-ear” earphones, or “ear-bud type” earphones might appear to effectively “seal” the earphone assembly into the listener's ear-canal, an earphone thus positioned and located does not provide an effective acoustic seal between the listener's ear canal and the ambient environment, because low-frequency sound vibrations can still pass through the rubber flanges themselves. In addition, acoustic coupling-impedance pathways are frequently built in to the earphone structures in order to “tune” the acoustic performance for a desired frequency response at the listener's ear, as disclosed, for example, in U.S. Pat. No. 4,852,177, and these pathways allow sound energy to be transmitted through the actual structure of the earphone and into the ear-canal. Such leakage pathways are often implemented as very small, circular apertures (diameter <1 mm) bearing acoustically resistive nylon mesh material, or similar, and situated between the outer ambient and the internal space situated in front of an internal microspeaker or the space behind it, or situated between these two internal spaces themselves (or some combination thereof).

In general, environments for travellers are seldom quiet, and high levels of ambient noise can be encountered, for example during air travel, or when travelling by subway trains and motor vehicles. Consequently, it is advantageous to incorporate an ANC system into ear-phones and headsets such that the music and communications are intelligible, and so that the listener is not required to increase the listening volume to an excessively high level in order to overcome the background noise (an action which is undesirable for health reasons).

There are two alternative technologies that can be utilised for ambient noise-cancellation, known respectively as the “feedforward” method, and the “feedback” method. An ANC system based on the feedback method is disclosed in U.S. Pat. No. 4,985,925 whereas an ANC system based on the feedforward method is disclosed in U.S. Pat. No. 5,138,664.

The present invention is applicable to ANC systems based on either method, but the feedforward method is preferred, and thus systems based on that technology will be described hereinafter.

In the feedforward method, incoming ambient-noise signals are detected by means of a small microphone, and used to create phase-inverted noise signals which are played through a microspeaker into an ear of the listener. The timing is organised such that such that the noise signal and its phase-inverted counterpart arrive together at the listener's tympanic membrane, at which point destructive cancellation occurs between the two signals provided that the phase-inverted (cancellation) signal is of equal magnitude and opposite polarity to the ambient noise signal, in which ideal case, the resultant, summed signal is zero. In principle, this is an elegant way to create an ANC system, but its practical implementation, in a cost effective manner, presents substantial difficulties.

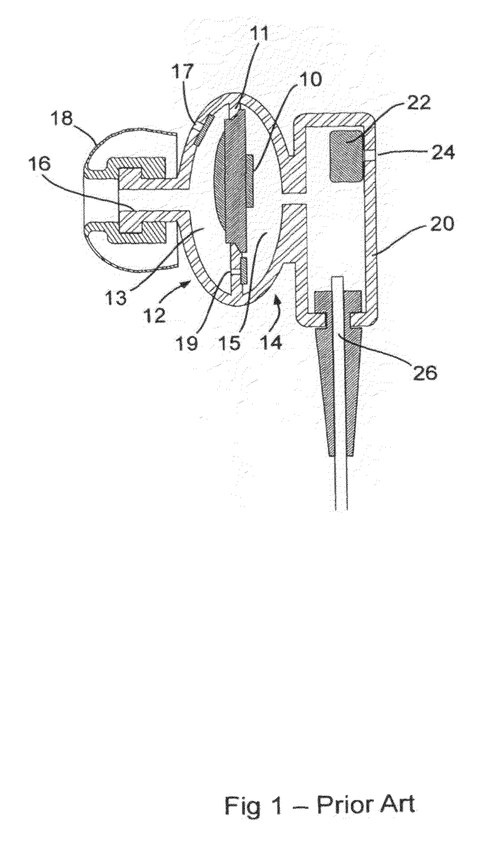

The general structure of a typical prior art feedforward ANC ear-bud type earphone is shown in FIG. 1 of the accompanying drawings, to which reference will now be made.

In FIG. 1, a microspeaker 10 is sealed into a central substrate 11, which is sealed to both a front enclosure 12 and a rear enclosure 14. The front enclosure 12 bears an outlet port 16, intended to face into a user's ear canal, and on to which rubber ear-bud flanges 18 are affixed. The rear enclosure 14 supports a housing 20 for a small electret microphone 22, typically 4 mm or 6 mm in diameter, orientated outwards, as shown, and coupled via a small diameter inlet tube 24 to the external ambient.

The rear housing 20 is also used to carry and locate the electrical flex connections, schematically shown at 26, to and from the microspeaker and microphone; though the internal cabling and connections are not shown in FIG. 1, for clarity. The connections 26 link the earphone electrically to a small “pod” unit (not shown) that houses a battery supply and electronic processing circuitry. The volume of air in a front cavity 13, defined by the front enclosure 12, and, lying between the front of the microspeaker 10 and the outlet port 16, is termed the “front volume”, and similarly the volume of enclosed air in a cavity 15, lying behind the microspeaker 10 and defined by the rear enclosure 14, is termed the “rear volume”. It will be appreciated that, generally, the wiring to the microspeaker 10 is hermetically sealed in place with glue which acoustically isolates the rear volume of cavity 15 from the microphone housing 20.

In addition, as previously mentioned, it is common to introduce one or more deliberate acoustic leakages in order to modify the frequency response to provide a high-quality sound reproduction. Such leakages are usually provided as acoustic resistors, formed by sealing a thin, acoustically resistant nylon mesh (or similar material) over a small diameter (<1 mm), short length (<1 mm) aperture in the housing. It is beneficial to deploy such a resistance between the front volume 13 and the ambient, and/or between the front and rear volumes 13, 15. This is also useful for preventing a total hermetic seal of the earphone in the ear of the user, which causes an unpleasant “blocked ear “feeling. Both of these resistor positions are shown in FIGS. 1, at 17 and 19 respectively. These resistive impedances are very critical components, hence even small changes in their value can have a great influence on the frequency response and overall transfer function of the earphone.

In the feedforward cancellation method, as previously indicated, the incoming ambient-noise signals detected by the microphone 22 are fed to the pod, which (inter alia) contains signal processing circuitry configured to create phase-inverted noise signals. These inverted signals are then fed back to the earphone and played through the microspeaker 10 into the ear of the listener, such that (ideally) and provided that the noise signal and its phase-inverted counterpart arrive together at the tympanic membrane, destructive cancellation of the two acoustic signals occurs because the phase-inverted (cancellation) signal is of equal magnitude and opposite polarity to the ambient noise signal, and therefore the resultant, summed acoustic signal is zero.

In order to achieve substantial noise-cancellation, it is important that the synthesised cancellation signal closely matches the directly received noise signal in terms of both amplitude and phase at all relevant frequencies. In this respect, it is possible to calculate the tolerances that can be allowed for a given noise-cancellation factor. For even a relatively modest amount of cancellation, say a 9 dB reduction (about 68%) of the perceived noise level (even assuming perfect phase-matching between the two signals), the amplitude of the cancellation signal must be within 3 dB of the amplitude of the noise signal. Similarly, even if the amplitude matching of the two signals is perfect, the phase value of the cancellation signal must lie within 20° of that of the noise signal to achieve 9 dB cancellation. If there are both amplitude and phase differences between the two signals, of course, the noise-cancellation effectiveness is even further reduced.

In practical terms, it is desirable to achieve a noise-cancellation reduction of about 20 dB (i.e. a noise signal difference of −20 dB) throughout the relevant part of the spectrum, which might encompass the frequency range 50 Hz to several kHz for a typical ear-bud type earphone. This 20 dB noise-cancellation factor criterion (assuming perfect phase-matching) requires that the amplitudes of the noise signal and the cancellation signal differ by no more than 0.9 dB at the ear of the listener throughout the frequency range. In practice, this is a very demanding requirement.

These critical matching criteria create problems in the production of ANC ear-phones that the present invention seeks to alleviate, particularly because the microspeakers and microphones used in their construction cannot be manufactured with adequate precision in terms of their electroacoustic and acoustoelectric sensitivities to allow random component selections to be made. In this respect, suitable microspeakers in the diameter range 9 mm to 13 mm currently are typically supplied with a sensitivity tolerance range of ±3 dB, and suitable 4 mm and 6 mm electret microphones currently are typically supplied with tolerances of ±3 dB or ±4 dB. Consequently, in the extreme, there is the possibility that any single random microphone-microspeaker combination, as used together in an ANC earphone, might have a combined sensitivity factor that could differ by as much as 6 dB from the average, and expected, value. Accordingly, it is not possible to manufacture effective ANC earphones without taking these sensitivity variations into account, and then compensating for them in some manner.

Such compensation can be carried out simply by adjusting the noise-cancellation signal-level as part of the signal-processing (filtering) and amplification stage, for example by incorporating a trimming potentiometer to afford ±6 dB signal-level adjustment.

Clearly, such a gain-setting adjustment method cannot be a purely electronic process, because several acoustic pathways form part of the overall ambient-earphone-ear system. Consequently, the obvious solution is to calibrate the fully assembled earphones on an artificial ear device, such as a Bruel & Kjaer Type 4157 Ear Simulator for use with insert earphones, by exposing the earphones to a noise source and then adjusting the ANC signal-level trimming potentiometers so as to minimise the residual noise signal that is registered by the microphone in the ear simulator, i.e. the external ambient noise signal detected at each artificial ear is “nulled” as far as possible by trimming its respective potentiometer. However, manual calibration of this type is not readily compatible with a mass-production assembly line for the following reasons.
1. It is a time-consuming, and therefore costly, process, perhaps taking up to 2 minutes to calibrate an earphone pair. At 30 calibrations per hour, this represents only 210 units per operator, per 7-working-hour day, and this limits severely the rate at which earphones could be manufactured by a skilled operator;
2. It is a labour-intensive process, requiring an operator to insert, individually, each earphone into a small ear-canal adaptor, and then adjust a small, fragile potentiometer very carefully and accurately, and then de-mount the earphones without damaging the frail rubber ear-bud flanges;
3. The overall ear-canal system might have different acoustic properties from a human ear, which could introduce errors;
4. Errors might be introduced by small acoustic leakages if the ear-buds are not seated so as to form a perfect acoustic seal with the ear-canal adaptor; and
5. The system is not suitable for automation because the frail rubber ear-buds do not allow for easy insertion into, and removal from, an ear-canal simulator.

It is an object of the present invention to address these limitations and to eliminate the production-line requirement for the manual calibration of ambient noise-cancelling ear-bud type earphones by means including a modular earphone component for use with an associated electronic ANC system, capable of being easily and rapidly characterized in a production-line environment.

The module contains all of the critical components of an earphone ANC system, and, according to the invention from one aspect, comprises a common substrate carrying a microspeaker and an electret microphone, and configured to incorporate an acoustic resistor for controlling the acoustic properties of the earphone. This facilitates the production of ANC earphones because a manufacturer can elect to build the module into an earphone and provide the associated pod with a suitable trimming potentiometer that can be employed by the user to set the ANC performance as required.

Preferably, however, the combined performances of the microspeaker and the electret microphone of a module are classified into grades, and components in the associated pod are adjusted during manufacture and permanently set to take account of the performance grading of the components incorporated into a given module.

It is further preferred, when the grading system is used, that the associated pod is provided with a trimming potentiometer which the user can employ to achieve fine tuning of the ANC performance of an earphone fitted with such a module.

Preferably, the classification process used to grade the components of a module comprises the step of feeding known electrical signals to said microspeaker and deriving response signals from said microphone.

It is further preferred that the module comprises respective contact means electrically connected to each of said microspeaker and said microphone, whereby external connections may be made to the components of said module.

In preferred embodiments of the invention, said substrate comprises a substantially planar body with first and second major surfaces, and the module further comprises acoustic tuning means including a channel extending through the body of said substrate, and which particularly preferably is configured as an acoustic resistor.

In some preferred embodiments, the microspeaker is mounted into the body of said substrate with a forward emissive surface of said microspeaker disposed to emit sound outwardly from said first major surface; with the microphone supported by the second said major surface;

and with a rearward emissive surface of said microspeaker disposed to emit sound outwardly from said second major surface of the substrate.

Conveniently, the module further incorporates a printed circuit board mounted to said second major surface of the substrate and said printed circuit board supports said microphone.

In some particularly preferred embodiments of the invention, the module further comprises an information storage means capable of storing information indicative of a departure of the microphone or the microspeaker from one or more predetermined performance criteria, and of providing, upon interrogation, the stored information in a form usable to compensate for such departure.

Preferably, the information storage means is supported on the second major surface of the common substrate of the module and it is particularly preferred that the information storage means is supported by the aforementioned printed circuit board.

The information storage means preferably comprises an electronic memory device such as an EPROM or an OTP-ROM.

The invention also encompasses earphones containing modules of any of the kinds described above, configured to fit into the ear of a user and electrically connected to a separate unit, such as a pod unit, that contains the ambient noise-cancelling processing circuitry. A particularly preferred embodiment of this aspect of the invention comprises such an earphone configured for use with a headset for a cellular telephone, in which case there is an option that the electronic control circuitry for the earphone is incorporated into the handset of the cellular telephone, rather than into a separate pod unit.

The invention further encompasses classifying apparatus configured to receive for component grading a module of any of the kinds described above; said apparatus comprising first and second cavity-defining members and means for applying electrical signals to said microspeaker, for deriving electrical signals from said microphone and for providing an indication of the grading determined for the module.

Preferably, in such apparatus, said means for applying electrical signals, for deriving electrical signals and for feeding said signals comprise respective probes mounted to one only of said cavity defining members.

The invention further comprises methods, utilising such apparatus, for classifying the performance of the components incorporated into said modules.

In order that the invention may be clearly understood and readily carried into effect, certain embodiments thereof will now be described, by way of example only, with reference to the accompanying drawings, of which:

FIG. 1 has already been referred to and shows, in cross-sectional view, a feedforward ANC ear-bud of a kind known in the prior art;

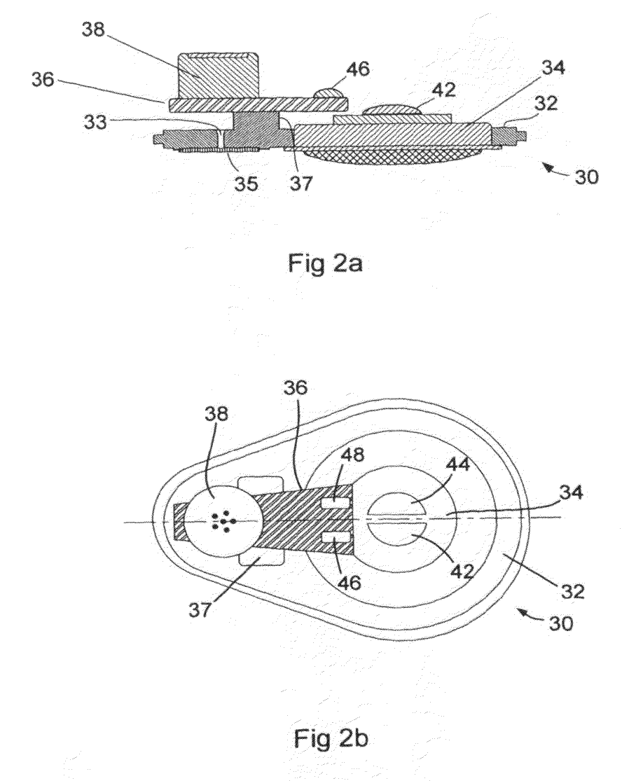

FIGS. 2(a) and 2(b) show, in lateral cross-section and plan views respectively, a module in accordance with one example of the invention;

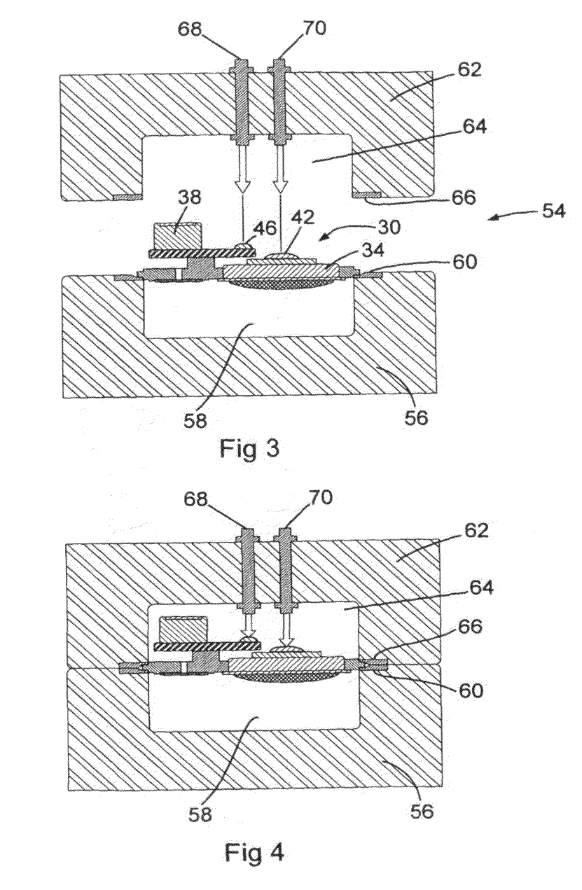

FIG. 3 shows, in cross-sectional view and in an opened condition, apparatus for classifying an ANC performance characteristic of the module of FIG. 2, and shows the mounting of the module therein;

FIG. 4 shows the apparatus of FIG. 3 in a closed condition, containing the module of FIG. 2 in a condition for classification;

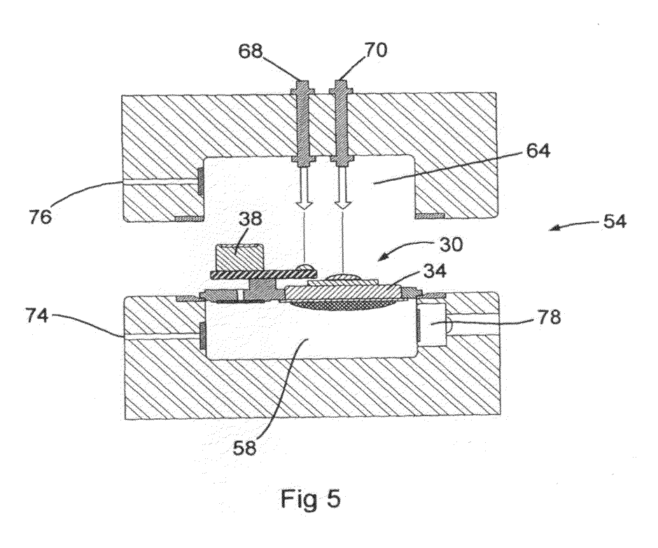

FIG. 5 shows the apparatus of FIGS. 3 and 4 in its opened condition, and modified to include an internal microphone and integral acoustic leakages;

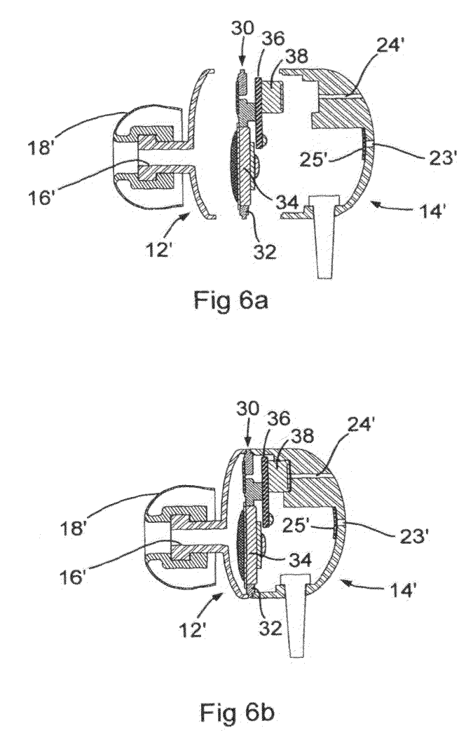

FIGS. 6(a) and 6(b) show, in exploded and assembled views respectively, the module of FIG. 2 incorporated into an earphone;

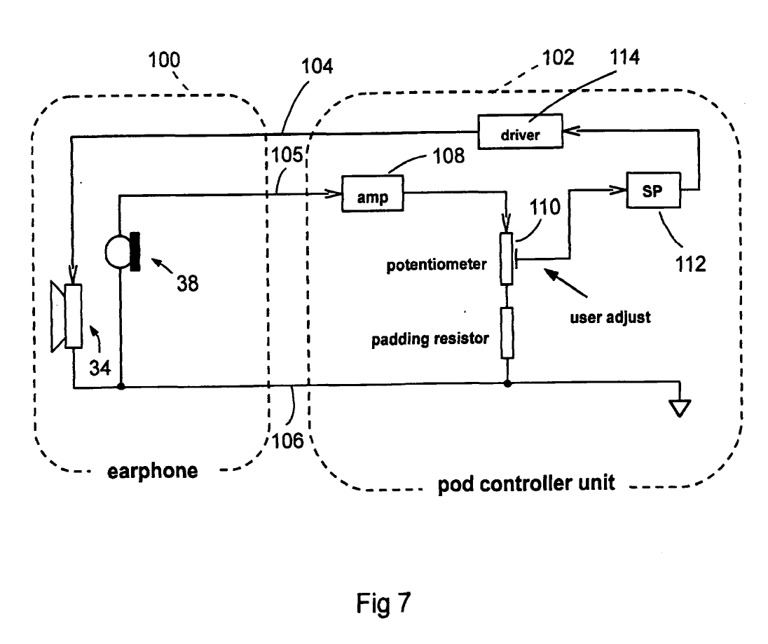

FIG. 7 is a block diagram showing schematically one channel of an ANC earphone system incorporating a module of the kind described with reference to FIG. 2 and a pod-mounted potentiometer device allowing a user to adjust the ANC performance to taste;

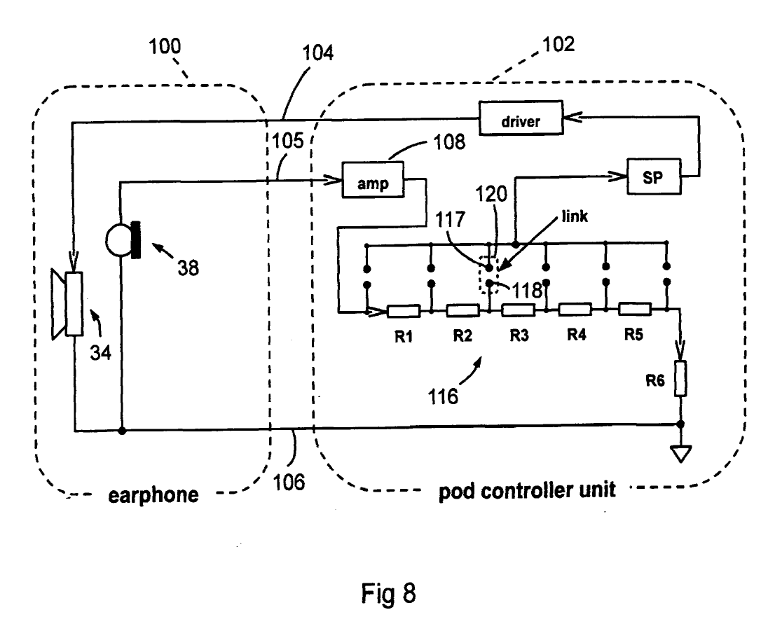

FIG. 8 is a block diagram showing schematically one channel of an ANC earphone system incorporating a graded module of the kind described with reference to FIG. 2, with a permanent adjustment made within the pod, during manufacture, to suit the grading;

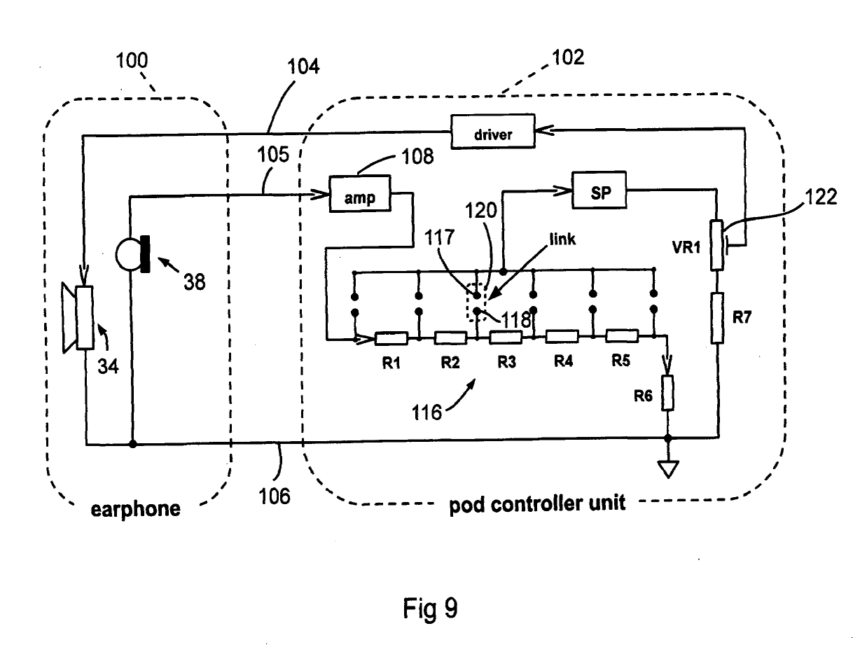

FIG. 9 is a block diagram showing schematically one channel of an ANC earphone system incorporating a graded module of the kind described with reference to FIG. 2, with a permanent adjustment made within the pod, during manufacture, to suit the grading, and a fine-tuning adjuster provided on the pod for operation by a user;

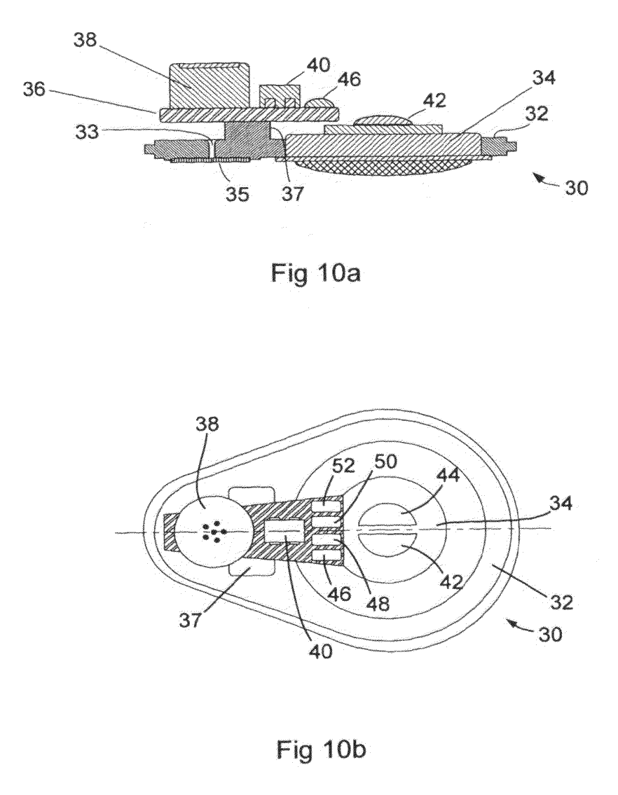

FIGS. 10(a) and 10(b) show, in lateral cross-section and plan views respectively, a module in accordance with a further and preferred example of the invention incorporating an information storage device;

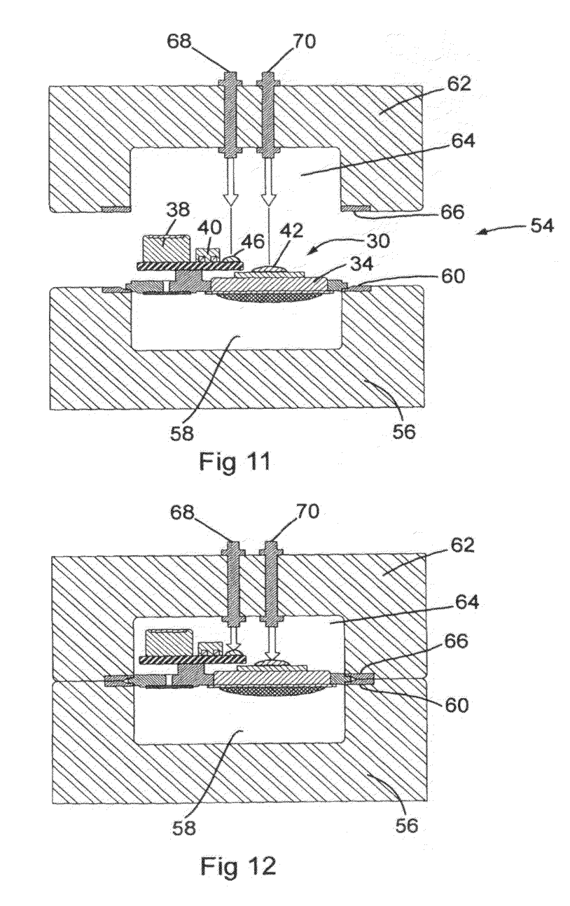

FIG. 11 shows, in cross-sectional view and in an opened condition, apparatus for classifying an ANC performance characteristic of the module of FIG. 10, and shows the mounting of the module therein;

FIG. 12 shows the apparatus of FIG. 11 in a closed condition, containing the module of FIG. 10 in a condition for classification;

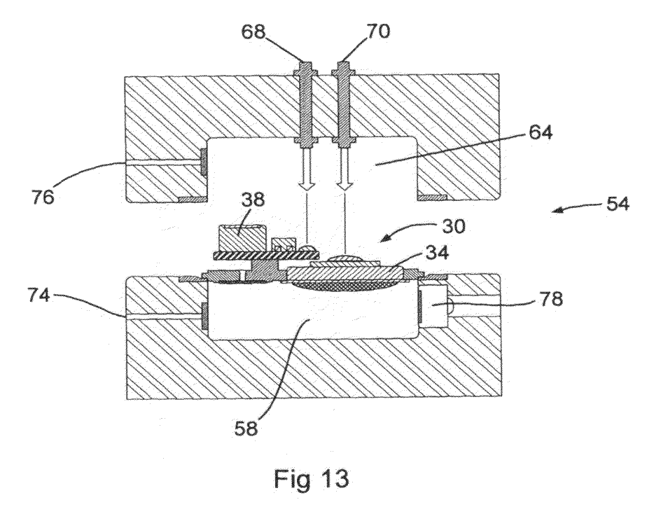

FIG. 13 shows the apparatus of FIGS. 11 and 12 in its opened condition, and modified to include an internal microphone and integral acoustic leakages;

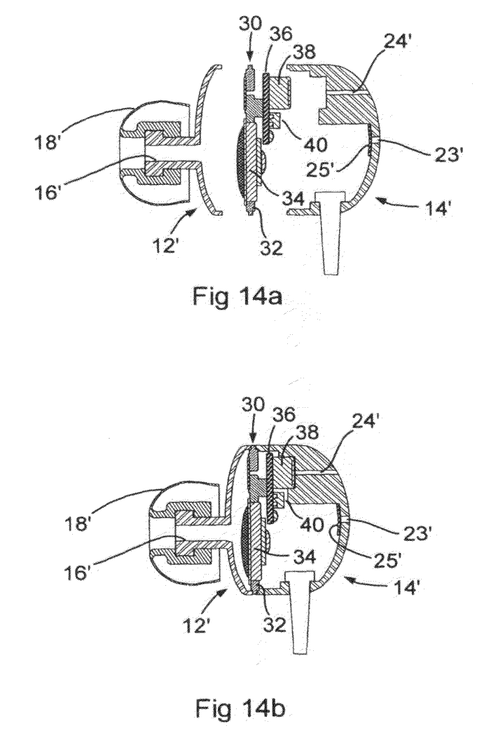

FIGS. 14(a) and 14(b) show, in exploded and assembled views respectively, the module of FIG. 10 incorporated into an earphone; and

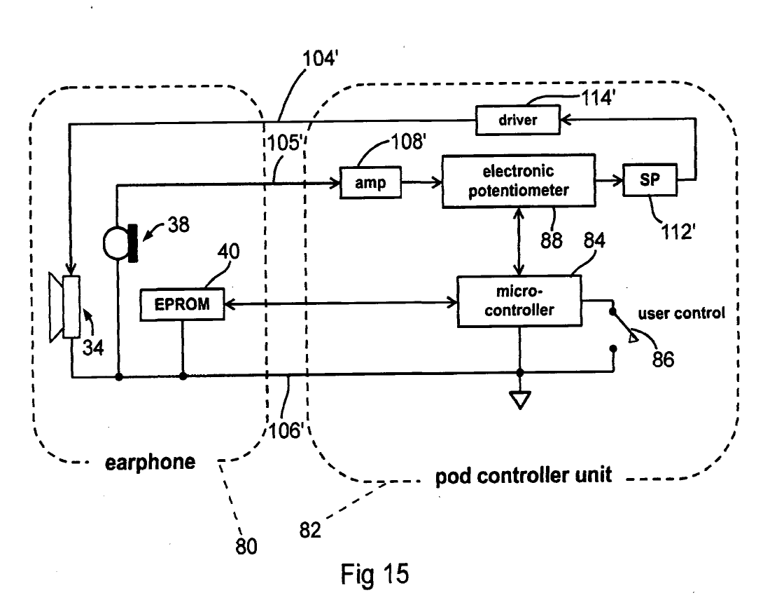

FIG. 15 is a block diagram showing schematically an ANC earphone system incorporating a module of the kind described with reference to FIG. 10 and a pod-mounted controller, responsive to adjustment signals from the informations storage device in the module, to adjust the ANC performance.

Currently, ANC manufacturers attempt to obtain individual components on an ad-hoc basis, but many are not suitable for ANC operation. For example, the acoustic mass and damping properties of microspeakers vary widely, and must be optimally engineered for ANC operation. Indeed, most “off the shelf” microspeakers are not well-suited for use in an ANC system. Similarly, the LF amplitude and phase responses of many commercially available electret microphones are not suitable for ANC use.

By utilising a microspeaker and microphone of suitable type which have been specifically engineered to be suitable for use in an ANC system, and in the form of a self-contained module in accordance with the invention, a manufacturer can be assured that the manufactured earphone will be capable of providing effective ANC operation.

The invention takes advantage of a unique concept, namely the attribution of a “sensitivity product” to any particular combined microphone and microspeaker pair. Because these two devices effectively act together in series in a feedforward ANC earphone, their sensitivities can be multiplied together, and it is this factor (called the “sensitivity product” (or briefly “SP”) herein) that determines the amount of gain adjustment required from a predetermined, nominal average sensitivity product value. Knowledge of the sensitivity product of a microphone-microspeaker pair enables an accurate ANC signal level adjustment to be pre-set electronically, without the need for a manual calibration procedure.

For example, if a particular microphone exhibits a sensitivity 2 dB greater than an average value, and its associated microspeaker exhibits a sensitivity that is 0.5 dB less than an average value, then the combined sensitivities of the two—the sensitivity product—is +1.5 dB different to the nominal average sensitivity product value. Accordingly, to compensate for this greater-than-average sensitivity, the ANC signal level should be set to a value 1.5 dB below that which is required for a nominal average sensitivity product value. This compensating adjustment is called herein the “sensitivity product correction factor” (“SPCF”).

The nominal average value is determined firstly by selecting a module-based earphone in which both the microphone and the microspeaker possess respective, known sensitivities that are close to the average value of their production batches (a benchmark sometimes referred to as a “golden sample”), and consequently the associated sensitivity product is representative of an average for said batches. Next, the optimal ANC signal level for this benchmark sample is determined using an ear simulator, as described above, and this value represents the ANC signal level associated with the nominal average sensitivity product value.

Similarly, the module-type format, which contains all of the critical ANC elements, including the two transducers which both feature unknown, imprecisely-defined sensitivities owing to manufacturing tolerances, enables a simple and rapid classification system to be devised for measuring the sensitivity product of the module (and also the individual sensitivities of the microspeaker and microphone), which can be labelled on to the module itself, or which could allow the fabricated modules to be pre-sorted, or screened into batches; each batch containing modules having similar sensitivity products.

For example, each batch might encompass a SP interval of 1 dB, such that an overall SP range of ±3 dB could be covered by six batches at 1 dB intervals.

The present invention provides (inter alia) an electroacoustic module for use as the primary component in the mass-production of ambient noise-cancelling earphones, applicable to both feedback and feedforward systems. As previously mentioned, however, the descriptions and examples herein relate solely to the feedforward method. The module is used in conjunction with a pre-assembly classification method and system, prior to earphone construction, and, when in use by a listener, it is used in conjunction with the signal-processing electronics required to provide the ANC filtering, audio amplification and earphone-driver functions, typically situated in an in-line “pod” on the connector cable between the earphones and the music and audio input plug or connector.

The module unit comprises the critical, active components of an ANC earphone structure (primarily the microphone and microspeaker), together with an acoustic conduit bearing an acoustic resistor; the module as a whole being implemented as a small, robust, self-contained unit to which acoustic and electronic coupling can rapidly and effectively be made. One example of this is shown in FIG. 2, although it will be appreciated that the component detail and relative positioning of the component elements can be varied without departing from the invention.

Referring in detail to FIG. 2, the module 30 comprises a substrate 32 of any convenient non-conductive and self-supporting material, such as polycarbonate or other rigid plastic material, which is shaped for compatibility with the physical parameters of a desired earphone format. Supported on the substrate 32 are a microspeaker 34 and a printed circuit board 36 which in turn supports a microphone 38, such as an electret microphone. Open electrical connection to the microspeaker 34 is provided via solder bumps 42 and 44, and to the microphone 38 via solder bumps, 46 and 48.

The substrate 32 of the module 30 is thin and largely planar in nature, having upper and lower surfaces, and is formed with a suitable aperture into which the microspeaker 34 is mounted using an air-tight sealant, such as a glue or gasket material, around its perimeter so as to expose and orient the frontal and rearward emission planes of the microspeaker to the air adjacent to the lower and upper surfaces of the substrate, respectively.

A second, much smaller, aperture is formed in the substrate 32, adjacent the microspeaker aperture, to accommodate an acoustic couple through the substrate itself, so as to link acoustically the air adjacent to the lower and upper surfaces of the substrate. Preferably, the couple is an acoustic resistor, comprising a channel or conduit 33 having a defined cross-sectional area and length, overlain by a layer 35 of a material having an acoustically resistive property, such as thin nylon mesh or sintered metal or similar. Typically, an aperture of less than 1 mm diameter and 1 mm length is suitable, in combination with a thin disc of suitably dense nylon mesh, several millimetres in diameter. In this embodiment, the layer 35 takes the form of a 4 mm diameter resistive mesh disc, symmetrically overlying the channel or conduit 33. The acoustic impedance properties of the acoustic couple can be varied by selection of the conduit dimensions and mesh density, and this is a critical feature for tuning and adjusting the frequency response of the earphone.

The substrate 32 also carries, as mentioned, a PCB 36, which is typically 2 mm by 6 mm in size, and, in the example shown, the PCB mounting area is formed on a small pillar 37 in order to make effective use of the available substrate area. This (inter alia) allows space above the area occupied by the acoustic couple 33, 35 to be used. The sub-miniature microphone 38 is mounted on to the PCB 36, and optionally, the microspeaker 34 can be wired to it also, though in the embodiment shown in FIG. 2, the speaker connectors are not so wired. The PCB 36 is arranged so that appropriate connections to the microphone 38 (and the microspeaker 34, if it is wired to the PCB) are made to spaced-apart contact pads as already mentioned; the pads in this example being constituted by solder bumps 42 through 48, suitable for being contacted electrically via spring-loaded contact probes such as 68 and 70 (see FIGS. 3, 4 and 5). These pads are also suitable for soldering connecting wires thereto, following a classification stage.

Typically, the microspeaker 34 has a diameter in the range 8 mm to 13 mm, and the microphone 38 is a sub-miniature electret type, having a diameter between 4 mm and 6 mm.

A bar-code or other label can be used to tag the sensitivity product information to the module, or a simple colour code scheme could be used to represent the sensitivity product value, and denote which sensitivity batch the module belongs to. Ideally and preferably, the sensitivity product of the module is measured using a system that replicates closely the acoustic conditions and loading that are representative of the operating conditions present when the module is used in an earphone that is coupled to the ear of a listener. The acoustic conditions must be constant and effective; for example, free from spurious acoustic leakages that would interfere with the measured values. In addition, it is desirable to carry out the measurement in a way that is tolerant of any unavoidable, production-line background noise.

The module can be coupled readily to a simple classification unit, as shown in FIG. 3, capable of providing an indication of the sensitivity product of the in-built microspeaker and microphone, or their respective individual sensitivities and recording this information for future use, and/or of using the information to grade, or screen, the modules into batches having similar sensitivity-product values. The module, bearing all of the critical components, can be encased between simple plastic front- and rear-housings to form an earphone assembly without said housings having a gross influence on the anticipated various electroacoustic and acoustoelectric transfer functions, thereby affording a manufacturer some freedom in the design of the earphone exterior, and allowing one single signal-processing ANC filter-function to serve various differing versions of module-based ANC earphones.

The classification unit used to grade the modules can be engineered in a variety of ways, as will become clear, including a batch version that is capable of pre-calibrating a plurality of modules simultaneously and thereby increasing the rate of production proportionately. However, in its simplest form, as shown in FIG. 3, the classification unit 54 comprises a lower platen 56 bearing a small (lower) cavity 58 with an elastomeric seal 60 around its perimeter, and an upper platen 62 bearing a similar (upper) cavity 64 and seal 66, the upper platen 62 supporting an array of several (in this example four) spring-loaded electrical test probes such as 68 and 70, each configured so as to traverse the upper platen 62 and extend into the upper cavity 64 to make electrical contact with a respective one of the solder bumps 42 through 48 provided on the module 30, during the module classification process, when the platens 56 and 62 are closed together in sealing relationship, as shown in FIG. 4.

The test probes such as 68 and 70 are coupled to a computer-based automated test system conditioned to transmit analogue signals to, and from, the module 30. The module 30 is effectively sandwiched between the two platens 56 and 62 for the module classification process, such that its upper and lower surfaces are acoustically coupled and sealed each to only the respective cavities of the platens, and such that its relevant electrical connections become electrically connected to the test probes such as 68 and 70, and thence to external electronic circuitry. Acoustic coupling from the cavities to the external ambient can be incorporated, so as to prevent large pressure artefacts during closure, and one or more internal microphones can also be integrated into the classification unit, as is shown in FIG. 5.

The ANC processor unit is contained in a conventional in-line “pod” unit, together with the battery, user controls and audio socket for music and audio input as is usual in current design. It comprises conventional ANC processing, including two, ganged potentiometer arrangements which control the respective signal levels of the left- and right-channel ANC signals.

The potentiometer arrangements can be implemented either as a variable, user-adjustable component, or so as to have a pre-settable, fixed-gain value, selected from one of several pre-determined values by an electrical link, such as a soldered joint connection between two solder pads.

In FIG. 3, the classification unit 54, in which a module 30 to be graded is located, is shown in its “open” position prior to module classification. The small cavity 58 formed in the lower platen unit 56 is dimensioned to have a similar volume to that of the human ear-canal when terminated by an in-ear earphone, which is approximately 0.85 ml (850 mm³). The upper platen unit 62 bears a similar-sized cavity 64, incorporating an array of several spring-loaded electrical test probes such as 68 and 70, configured so as to make electrical contact with the module when the classification unit 54 is closed, as it is during the classification process, as shown in FIG. 4. The test probes are coupled to a computer-based automated test system for transmitting analogue signals to, and from, the module. The upper and lower platen units may be hinged together to facilitate mutual alignment.

The classification process is initiated by closing the upper platen 62 down on to the lower platen 56, such that the module 30 becomes effectively sandwiched between the two platens, as shown in FIG. 4, whereby its upper and lower surfaces are acoustically coupled and sealed each to only the respective cavities of the platens, and such that the relevant electrical connections on its PCB 36 and microspeaker 34 become electrically connected to the test probes, and thence to external electronic circuitry. A switch (not shown) detects platen closure and initiates a computer controlled sequence of events as follows.
1. A fixed-frequency sine-wave signal, having a known reference voltage, is fed to the microspeaker 34, which generates acoustic signals in both upper and lower platen cavities. These two acoustic signals, opposite in phase, are very similar in amplitude, because the platen cavity volumes are substantially the same, modified only by the slightly different intrusion volumes of the module's upper- and lower-surface topographies.
2. The module's microphone 38, being exposed to the fixed frequency audio signal in the upper platen cavity 64, generates a corresponding signal that is transmitted to the external measuring means via a respective pair of the spring-loaded connectors. This microphone signal, being derived from its associated microspeaker 34 using a reference signal source, represents the sensitivity product of that particular module 30, and is measured and recorded.
3. The computer indicates that the module classification process has been completed, by displaying a prompt, and a data listing related to the process. Quality control limits can also be introduced at this stage so as to alert the operator to failed or out-of-specification components.

In practical use, the time taken for the above classification process, excluding the positioning and removal of the module 30 from the classification unit 54, is less than 1 second, and so the invention facilitates mass-production of ANC earphones. In principle, a larger platen system could accommodate, for example, a 4×4 matrix, bearing 16 modules, and classify them all simultaneously. Furthermore, robotic automation is possible, because the modules are mechanically robust, and there are no frail rubber ear-buds that might be torn.

By sandwiching and sealing the module between the platens, it is isolated from background noise. Moreover, by using a single calibration frequency, typically 500 Hz, it is possible to use a band-pass filter to virtually eliminate extraneous background noise from the microphone signal during the classification process.

The system can be further refined by incorporating acoustic coupling means between one or both of the platen cavities and the external air, so as to prevent potentially large pressure artefacts in the cavities at the point of closure. This is shown in FIG. 5, where there is formed an acoustic resistor 74, 76 respectively linking each platen cavity 58, 64 to the ambient. Each acoustic resistor is formed, as noted earlier in the description of the module, by means of a narrow tube between the platen cavity and the external air, with a resistive mesh overlying, and sealed against, one end of the tube (shown here in the inner end, actually within the platen cavity).

Another useful refinement is the incorporation of one (or more) calibrated internal microphones such as 78 into the classification unit 54, as also shown in FIG. 5, located, in this embodiment, in the lower platen unit 56. This allows measurement of the acoustic signal level in the lower cavity 58, and thus the sensitivity of the microspeaker 34 can be determined on its own (independently from its associated microphone 38 in the module unit 30). This is useful for screening the modules into batches of similar microspeaker sensitivity for use together, such that a good intrinsic left-right earphone loudness balance is provided in every earphone set. Also, this allows the sensitivity of the module's microphone to be calculated.

The now-classified module 30 comprises all of the critical, active components of an ANC earphone, and enables rapid and reproducible assembly of ear-bud type ANC earphone sets. Firstly, the module lower surface is sealed around its perimeter on to a moulded plastic frontal housing unit 12′, as shown in FIG. 6(a), which incorporates an outlet tube 16′ on to which is mounted a rubber ear-bud flange 18′. Next, a rear housing unit 14′, into which the electrical connecting flex has been threaded, is positioned close to the module 30, and then the flex connections are soldered on to the PCB 36 and microspeaker 34. Finally, the rear housing unit 14′ is sealed on to the periphery of the rear surface of the module 30, using glue or other means. At the same time, the module's microphone 38 is sealed into a cavity in the rear housing 14′, such that the microphone inlet is coupled only to an inlet tube 24′ formed in the rear housing, and which passes through the housing to the external ambient. A rear vent 23′, preferably comprising an aperture at least 3 mm in diameter, is also provided between the rear volume of the earphone and the external ambient. This ensures that the compliance of the acoustic load presented to the rear of the microspeaker diaphragm is not restricted, which would otherwise impair the frequency response.

The rear vent 23′ can also be provided, as shown at 25′, with a resistive mesh overlay, according to the frequency response requirements. The fully assembled earphone is shown in FIG. 6(b).

It will be appreciated that the assembly of an earphone based on the module 30 is a simple process using minimal components and time, with the critical acoustic properties being defined by the module's internal acoustic couple impedance. This facilitates the mechanical and aesthetic design of the front and rear housing units because they are devoid of any critical acoustic elements; this simplifies the product design process and ensures that the resultant product is correctly functional.

The invention can be deployed in its simplest form without use of the classification stage. FIG. 7 shows a block diagram of one channel of this first embodiment of the invention. The left-hand box 100 contains the module-based earphone elements, i.e. a microspeaker 34 and a microphone 38, and the right-hand box 102 contains the relevant components of the associated electronics pod unit. The connections between the two units comprise analogue connections 104, 105 to the microspeaker and microphone respectively, and a common ground connection 106.

The pod controller electronic circuitry for each audio channel comprises a microphone pre-amplifier 108 (and microphone bias voltage), potentiometer means 110, signal-processing means (electronic filtering) 112 and an audio driver stage 114. An external audio signal (not included in FIG. 7), such as music or a telephony channel, can also be fed to the driver stage 114, and summed with the ANC signal to be heard by the user. The potentiometer 110, having L and R channels “ganged” (coupled) together, is user-adjustable and provides gain adjustment of the cancellation signal so as to encompass the likely sensitivity-product range of the modules, say ±2 dB, together with a safety margin of about ±1 dB, thus requiring an adjustment range of 6 dB. Accordingly, the user can select the “null point” of the module, and no production-line calibration or classification is required.

This system is a very low-cost one, where no classification or batching is required. However, its use is not particularly intuitive for the user, because the ANC null point is in an undefined position in the potentiometer, and the adjustment is quite coarse and rather sensitive. However, by classifying and batching the modules, as described next, a superior product can be engineered.

FIG. 8 shows a second embodiment of the invention, which utilises the module after the classification stage has been used for determining the transducer sensitivities and SP and grading them. This is similar to the system of FIG. 7, but the user-adjustable potentiometer (110) is replaced by an array 116 of five resistors (R1 to R5), together with an additional padding resistor, R6. The circuit nodes linking the six resistors are connected to an array of solder pads, such as 117 and 118, that are adjacent to a common, linking conductor strip, e.g. 120, such that a solder bridge can be formed readily between any chosen node and the common conductor, thus forming an electrical link. It will be appreciated that this potentiometric arrangement allows use of six different attenuation settings for controlling the gain of the ANC system, from which one can be chosen, in accordance with the grading allocated to the particular module employed, and permanently pre-set. In the arrangement depicted in FIG. 8, for example, the potentiometer gain (attenuation) factor is given by the following relationship.

$$Gain = \frac{R 3 + R 4 + R 5 + R 6}{R 1 + R 2 + R 3 + R 4 + R 5 + R 6} \qquad ( 1 )$$

Hence, by characterizing the SPs of the modules and grading them into 1 dB interval batches, and then pre-setting the appropriate potentiometer gain level to correspond to the mean SP value of any particular batch, no user-adjustable control is required and the electronic gain will be matched to the module's SP within ±0.5 dB. This six-resistor configuration corresponds to a six-batch system (e.g. ±3 dB in 1 dB intervals), and can of course be extended, as required, to encompass a greater number of batches and cater for a larger variation in SP sensitivity.

FIG. 9 shows a preferred, third embodiment of the invention which combines the advantages of both of the previous two embodiments. By adding a user-adjustable potentiometer arrangement 122 to the preset gain potentiometer system of the second configuration, this third embodiment provides a system capable of using a smaller number of batches than that of the second embodiment, and it also allows the user to fine-tune the setting for optimal ANC, but this time over a narrower range. Consequently, the user-adjustment is not a coarse one; the potentiometer setting is always reasonably close the optimum null point, and the ANC is always greater than, say, 10 dB, throughout its entire range.

For example, a three-batch system, based on 2 dB intervals (covering a module SP range of 6 dB), could be combined with a user-adjustment range of 3 dB, to provide at least 12 dB of active cancellation for all user settings, and up to 30 dB or more at the null point.

The preset potentiometer arrangements of FIGS. 8 and 9 could be set so as to have differing left and right channel values, if required, to accommodate differing left and right speaker sensitivities. Also, the same potentiometric methods could be applied to the music channel circuitry in order to effect a good left-right balance.

It will be appreciated that the resistor chains shown in FIGS. 8 and 9 can be simplified if desired by utilising combinations of binary-weighted resistors whereby, for example, resistors of resistance R, 2R and 4R can be selectively interconnected to provide seven different resistance values.

A particularly preferred embodiment of the invention will now be described with reference to FIGS. 10 to 15. In this embodiment, an electronic memory device is added to the module containing the microspeaker and microphone. This memory device can be primed with information indicative of the performance of the microphone and the microspeaker, thus enabling the earphone or other device incorporating to module to correct in situ for departures of the microspeaker and/or microphone from one or more preselected performance criteria.

This embodiment of the present invention thus provides a programmable electro-acoustic module for use as a primary component in the mass-production of ambient noise-cancelling earphones and, as with the preceding embodiments, it is applicable to both feedback and feed-forward ANC systems. For clarity of explanation, however, the following description will continue to relate solely to the preferred feed-forward systems. The module is used in conjunction with (a) a pre-assembly “classification” or “pre-calibration” method and system, employed, as described above, prior to earphone construction; and (b), when in use by a listener, it is used with a digitally-controlled unit integrated with the signal-processing electronics required to provide the ANC filtering, audio amplification and earphone-driver functions, typically situated in an in-line “pod” on the connector cable between the earphones and the music and audio input plug or connector.

The module unit in this embodiment therefore comprises the critical, active components of an ANC earphone structure (primarily the microphone and microspeaker), together with an electronic (or other) information storage means, implemented as a small, robust, self-contained module to which acoustic and electronic couplings can rapidly and effectively be made. One example of this is shown in FIG. 10, although it will be appreciated that the component detail and relative positioning of the component elements can be varied without departing from the invention.

Referring in detail to FIGS. 10(a) and 10(b), which are similar to FIGS. 2(a) and 2(b), and in which the numbering used in previous Figures is retained for similar components, the module 30 comprises a substrate 32 which, as in previous embodiments, may comprise any convenient non-conductive and self-supporting material, such as polycarbonate or other rigid plastic material, and which is shaped for compatibility with the physical parameters of a desired earphone format. Supported on the substrate 32 are the microspeaker 34 and a printed circuit board 36 which, in turn, supports a sub-miniature microphone 38, such as an electret microphone, and an information storage means, constituted in this example by an electronic memory component such as an EPROM 40. Open electrical connection to the microspeaker 34 is provided via solder bumps 42 and 44, and to the microphone 38 and the memory component 40 via respective pairs of solder bumps, 46, 48 and 50, 52.

As indicated in FIGS. 11 to 13, the module can be coupled readily to a classification unit 54 of the same general kind as that described hereinbefore with reference to FIGS. 3 to 5, but adapted such that, in addition to classification or “pre-calibration”, for assessing the sensitivity product of the in-built microspeaker 34 and microphone 38, or their individual sensitivities, it is also capable of storing this value (or values) on to the memory component 40; typically in less than one second. The module 30 carries an acoustic tuning means, such as a suitable acoustic resistor, such that the module can be encased between simple plastic front- and rear-housings to form an earphone assembly without said housings having a gross influence on the anticipated various electro-acoustic and acousto-electric transfer functions, thereby affording a manufacturer freedom in the design of the earphone exterior, and allowing one single signal-processing ANC filter-function to serve various differing versions of module-based ANC earphones.

The classification unit 54, as previously mentioned, can be engineered in a variety of ways, including a batch version that is capable of pre-calibrating a plurality of modules simultaneously and thereby increasing the rate of production considerably. However, in its simplest form, as shown in FIG. 11, the classification unit 54 comprises a lower platen 56 bearing a small (lowermost) cavity 58 with an elastomeric seal 60 around its perimeter, and an upper platen 62 bearing a similar cavity 64 and seal 66, the cavity incorporating an array of several (in this example six) spring-loaded electrical test probes such as 68 and 70, each configured so as to make electrical contact with a respective one of the solder bumps 42 through 52 provided on the module 30, during the classification process, as shown in FIG. 12.

The test probes such as 68 and 70 are coupled to a computer-based automated test system conditioned to transmit both analogue and digital signals to, and from, the module 30. The module 30 is effectively sandwiched between the two platens 56 and 62 for the pre-calibration process such that its upper and lower surfaces are acoustically coupled and sealed each to only the respective cavities of the platens, and such that its relevant electrical connections become electrically connected to the test probes such as 68 and 70, and thence to external electronic circuitry. Acoustic coupling from the cavities to the external ambient can be incorporated, so as to prevent large pressure artefacts during closure, and one or more calibrated internal microphones can also be integrated into the classification unit 54, as is shown in FIG. 13.

The digitally controlled ANC processor unit is, in this example, contained in a conventional in-line “pod” unit, together with the battery, user controls and audio socket for music and audio input as is usual in current design. It comprises conventional ANC feed-forward processing, together with a digital microcontroller unit and two electronic potentiometers which control the respective signal levels of the left- and right-channel ANC signals. The controller unit is used in conjunction with module-based earphones according to the present invention, with which it is linked, via wired connections, to the respective electronic memory components (such as 40) in the left- and right-earphone assemblies. When the ANC processor unit is activated by a user, the microcontroller electronically interrogates the left and right information storage means, and then compensates for any sensitivity variations from the anticipated average in both of the microspeakers and microphones, by setting the left-channel and right-channel electronic potentiometers to suitable SPCF-compensated values so as to provide maximum ambient noise-cancellation. When used in association with a cellular telephone however, it is an option that the ANC processor unit be incorporated into the telephone's handset, rather than into an external pod.

Reverting again to FIG. 10, the substrate 32 of the module 30 is thin and largely planar in nature, having upper and lower surfaces, and is formed with a suitable aperture into which the microspeaker 34 is mounted using an air-tight sealant, such as a glue or gasket material, around its perimeter so as to expose and orient the frontal and rearward emission planes of the microspeaker to the air adjacent to the lower and upper surfaces of the substrate, respectively.

As before, a second, much smaller, aperture is formed in the substrate 32, adjacent the microspeaker aperture, to accommodate an acoustic couple through the substrate itself, so as to link acoustically the air adjacent to the lower and upper surfaces of the substrate. Preferably, the couple is an acoustic resistor, comprising a channel or conduit 33 having a defined cross-sectional area and length, overlain by a layer 35 of a material having an acoustically resistive property, such as thin nylon mesh or sintered metal or similar. Typically, an aperture of less than 1 mm diameter and 1 mm length is suitable, in combination with a thin disc of suitably dense nylon mesh, several millimetres in diameter. In this embodiment, the layer 35 takes the form of a 4 mm diameter resistive mesh disc, symmetrically overlying the channel or conduit 33. The acoustic impedance properties of the acoustic couple can be varied by selection of the conduit dimensions and mesh density, and this is a critical feature for tuning and adjusting the frequency response of the earphone.

The substrate 32 also carries, as mentioned, a PCB 36, which is typically 2 mm by 6 mm in size, and, in the example shown, the PCB mounting area is formed on a small pillar 37 in order to make effective use of the available substrate area. This (inter alia) allows space above the area occupied by the acoustic couple 33, 35 to be used. The sub-miniature microphone 38 and the EPROM 40 are mounted on to the PCB 36, and optionally, the microspeaker 32 can be wired to it also, though in the embodiment shown in FIG. 2, the speaker connectors are not so wired. The PCB 36 is arranged so that appropriate connections to the microphone 38 and EPROM 40 (and the microspeaker 32, if it is wired to the PCB) are made to spaced-apart contact pads as already mentioned; the pads in this example being constituted by solder bumps 42 through 52, suitable for being contacted electrically via spring-loaded contact probes such as 68 and 70. These pads are also suitable for soldering connecting wires thereto, following a classification, or pre-calibration, stage.

Typically, the microspeaker 32 has a diameter in the range 8 mm to 13 mm, and the microphone 38 is a sub-miniature electret type, having a diameter between 4 mm and 6 mm. The EPROM 40 is not required to store much information: low-cost presently available devices that store 1024 bits being thus suitable for use in this application. Other, known, information storage devices can be used, including fusible links and one-time programmable read-only memories (OTP-ROMs). Optical devices can also be used to store the sensitivity product information, such as bar-code labels or printing. In the extreme, a simple colour code scheme, such as that used for electrical resistors, could be used to represent the sensitivity product value. However, a small capacity, low-cost EPROM is the preferred storage method, and can be used for storing additional useful information about the module, such as its serial number, date of manufacture, and so on.

Ideally and preferably, the sensitivity product of the module is measured using a system that replicates closely the acoustic conditions and loading that are representative of the operating conditions present when the module is used in an earphone that is coupled to the ear of a listener. The acoustic conditions must be constant and effective; for example, free from spurious acoustic leakages that would interfere with the measured values. In addition, it is desirable to carry out the measurement in a way that is tolerant of any unavoidable, production-line background noise.

In FIG. 11, the classification unit 54, in which a programmable module 30 is located, is shown in its “open” position prior to pre-calibration. The small cavity 58 formed in the lower platen unit 56 is dimensioned to have a similar volume to that of the human ear-canal when terminated by an in-ear earphone, which is approximately 0.85 ml (850 mm³). The upper platen unit 62 bears a similar-sized cavity 64, incorporating an array of several spring-loaded electrical test probes such as 68 and 70, configured so as to make electrical contact with the module during the pre-calibration process, as shown in FIG. 12. The upper and lower platen units 56 and 62 may be hinged together to facilitate mutual alignment.

The pre-calibration process is initiated by closing the upper platen 62 down on to the lower platen 56, such that the module 30 becomes effectively sandwiched between the two platens, as shown in FIG. 12, whereby its upper and lower surfaces are acoustically coupled and sealed each to only the respective cavities of the platens, and such that the relevant electrical connections on its PCB 36 and microspeaker 32 become electrically connected to the test probes, and thence to external electronic circuitry. A switch (not shown) detects platen closure and initiates a computer controlled sequence of events as follows.
1. A fixed-frequency sine-wave signal, having a known reference voltage, is fed to the microspeaker 32, which generates acoustic signals in both upper and lower platen cavities. These two acoustic signals, opposite in phase, are very similar in amplitude, because the platen cavity volumes are substantially the same, modified only by the slightly different intrusion volumes of the module's upper- and lower-surface topographies.
2. The module's microphone 38, being exposed to the fixed frequency audio signal in the upper platen cavity 64, generates a corresponding signal that is transmitted to the external measuring means via a respective pair of the spring-loaded connectors. This microphone signal, being derived from its associated microspeaker 34 using a reference signal source, represents the sensitivity product of that particular module 30, and is measured and recorded.

3. The difference between this measured signal and that of the nominal average sensitivity product value represents the sensitivity product correction factor (SPCF) for the module, which is then written to the EPROM 40 on the module's PCB 36 either as a direct value, in dB, or in another numbering scheme, or as an index number for use in a look-up table. Additional information can also be written to the EPROM 40 at this stage if required.
4. The computer indicates that the pre-calibration process has been completed, by displaying a prompt, and a data listing related to the process. Quality control limits can also be introduced at this stage so as to alert the operator to failed or out-of-specification components.

In practical use, the time taken for the above pre-calibration process, excluding the positioning and removal of the module 30 from the pre-calibration unit 54, is typically less than 1 second, and so the invention facilitates mass-production of ANC earphones. In principle, a larger platen system could accommodate, for example, a 4×4 matrix, bearing 16 modules, and pre-calibrate them all simultaneously. Furthermore, robotic automation is possible, because the modules are mechanically robust, and there are no frail rubber ear-buds that might be torn.

By sandwiching and sealing the module 30 between the platens, it is isolated from background noise. By using a single calibration frequency, typically 500 Hz, it is possible to use a band-pass filter to virtually eliminate extraneous background noise from the microphone signal during the pre-calibration process.

The system can be further refined by incorporating acoustic coupling means between one or both of the platen cavities and the external air, so as to prevent potentially large pressure artefacts in the cavities at the point of closure. This is shown in FIG. 13, where there is formed an acoustic resistor 74, 76 respectively linking each platen cavity 58, 64 to the ambient. Each acoustic resistor is formed, as noted earlier in the description of the module, by means of a narrow tube between the platen cavity and the external air, with a resistive mesh overlying, and sealed against, one end of the tube (shown here in the inner end, actually within the platen cavity).

Another useful refinement is the incorporation of one (or more) internal microphones such as 78 into the classification unit 54, as also shown in FIG. 13, located, in this embodiment, in the lowermost platen unit 56. This allows measurement of the acoustic signal level in the lower cavity 58, and thus the sensitivity of the microspeaker 34 can be determined on its own (independently from its associated microphone 38 in the module unit 30). This is useful for screening the modules into batches of similar microspeaker sensitivity for use together, such that a good intrinsic left-right earphone loudness balance is provided in every earphone set. The classified, or pre-calibrated, module 30 comprises all of the critical, active components of an ANC earphone, and enables rapid and reproducible assembly of ear-bud type ANC earphone sets. Firstly, the module lower surface is sealed around its perimeter on to a moulded plastic frontal housing unit 12′, as shown in FIG. 14(a), which incorporates an outlet tube 16′ on to which is mounted a rubber ear-bud flange 18′. Next, a rear housing unit 14′, into which the electrical connecting flex has been threaded, is positioned close to the module 30, and then the flex connections are soldered on to the PCB 36 and microspeaker 34. Finally, the rear housing unit 14′ is sealed on to the periphery of the rear surface of the module 30, using glue or other means. At the same time, the module's microphone 38 is sealed into a cavity in the rear housing 14′, such that the microphone inlet is coupled only to an inlet tube 24′ formed in the rear housing, and which passes through the housing to the external ambient. A rear vent 23′, typically a 3 mm diameter aperture, is also provided between the rear volume of the earphone and the external ambient, in addition to any parasitic acoustic coupling through the flex connector retaining grommet. This ensures that the compliance of the acoustic load presented to the rear of the microspeaker diaphragm is not restricted, which would otherwise impair the frequency response. The rear vent 23′ can also be provided with a resistive mesh overlay 25′, according to the frequency response requirements. The fully assembled earphone is shown in FIG. 14(b).

It will be appreciated that the assembly of an earphone from the module 30 is a simple process using minimal components and time, with the critical acoustic properties being defined by the module's internal acoustic couple impedance, and the sensitivity product correction factor being stored on its EPROM 40. This facilitates the mechanical and aesthetic design of the frontal and rear housing units because they are devoid of any critical acoustic elements; this simplifies the product design process and ensures that the resultant product is correctly functional.

FIG. 15 shows a block diagram of one channel of an ambient noise-cancelling earphone system, based on a pre-calibrated module. The left-hand block 80 contains the module-based earphone elements, and the right-hand block 82 contains the relevant components of the associated pod controller unit. The connections between the two units comprise analogue connections 104′ and 105′ respectively to the microspeaker 34 and from the microphone 38 on the module 30, a common ground connection 106′ and a digital connection to the EPROM 40 from a microcontroller 84 in the pod controller unit 82.

The pod controller electronic circuitry comprises the microcontroller 84 and associated switch and control means 86, together with, for each audio channel, a microphone pre-amplifier 108′ (and microphone bias voltage), electronic potentiometer means 88, signal-processing means (electronic filtering) 112′ and an audio driver stage 114′.

When the pod controller is switched on, or when initiated by the user, the microcontroller 84 interrogates the EPROM 40 in the earphone assembly 80, obtaining its sensitivity product correction factor, and then sets the electronic potentiometer 88 accordingly, to achieve the optimum ANC gain setting. This is preferably implemented by fading the potentiometer up to its required level, such that there are no sudden unpleasant electrical transients that would cause audible clicks.

Variations in the detail of the above process are possible. For example, after the earphone has been assembled, initiation of the microcontroller's EPROM interrogation sequence can be carried out on the production line, and the left- and right-channel SPCFs stored in the microcontroller's non-volatile memory for subsequent use, thus eliminating the interrogation cycle each time the earphones are powered up by a user.

The microcontroller and electronic potentiometer combination 84, 88 also allows additional valuable features to be incorporated into the ANC earphone system, including the following.
1. User adjustment, within limits, of the pre-set ANC level to accommodate any small physiological differences between individuals and the average value.
2. Aesthetically pleasing fade-up and fade-down of the noise-cancellation.
3. Temporary, timed mute function (ANC fade-down for a few seconds and then fade-up again, to allow brief conversations).
4. Automatic fade-down of ANC when not required, such as when used in a quiet room.

The overall gain of the amplifying components used in the ANC processing circuits can vary from unit to unit, being influenced, for example, by uncertainties in the resistance values of electronic potentiometers. Accordingly, it has been found useful (though not essential) to measure the gain of the overall processing circuitry at the assembly stage, to note the magnitude of any departure from a predetermined, standard gain level, and to store information defining such a departure, either in the electronic memory device 40 (if provided) or in a RAM incorporated into the microcontroller, or in a dedicated memory provided in the associated pod. In any event, the stored information, indicative of the magnitude of any departure of the electronics from the predetermined amplification setting, is then utilised, along with the SP data from the module 30, to compensate for the departure when the ANC circuitry is in use.

The gain of each channel (right and left) is readily measured by injecting a known audio signal at a given frequency (say 1 kHz) into the microphone input (e.g. at point 105′ in FIG. 15) and measuring the signal at the output node 104′ from the driver 114′ to the microspeaker 38, with the electronic potentiometers set at a known reference position, such as mid-gain. This procedure yields an actual gain value for the ANC electronics in the pod for comparison with a predetermined standard gain value, and a signal indicative of any departure from the standard gain is stored as mentioned above and utilised along with the corrective data from the module 30 to additionally compensate for variations in the amplification level.

1-18. (canceled)

19. An ambient noise-cancelling earphone incorporating a module comprising a common substrate carrying a microspeaker and an electret microphone, and configured to incorporate an acoustic resistor for controlling the acoustic properties of the earphone, and wherein said common substrate further supports an information storage means capable of storing information indicative of a departure of said microphone and/or said microspeaker from one or more predetermined performance criteria and of providing said information upon interrogation to compensate for said departure.

20. The earphone according to claim 19, wherein said substrate comprises a substantially planar body with first and second major surfaces, and wherein said acoustic resistor comprises a channel extending through the body of said substrate, and an acoustically resistive mesh overlay.

21. The earphone according to claim 20, wherein said microspeaker is mounted into the body of said substrate with a forward emissive surface of said microspeaker disposed to emit sound outwardly from said first major surface, with the microphone supported by the second said major surface, and with a rearward emissive surface of said microspeaker disposed to emit sound outwardly from said second major surface of the substrate.

22. The earphone according to claim 20, wherein said information storage means is supported by said second major surface of said common substrate.

23. The earphone according to claim 20, further comprising a printed circuit board mounted to said second major surface of the substrate and wherein said printed circuit board supports said microphone and said information storage means.

24. The earphone according to claim 19, wherein said information storage means comprises an electronic memory device.

25. The earphone according to claim 19, wherein said information storage means comprises non-electronic means.

26. The earphone according to claim 19, further comprising an acoustic port coupling sound from said microspeaker into the ear of a user, a noise-cancelling electronic processing means housed separately from the earphone and electrical connection means connecting said earphone to said electronic processing means.

27. The earphone according to claim 26, connected by said electrical connection means to a pod unit housing said noise-cancelling electronic processing means.

28. The earphone according to claim 26, connected by said electrical connection means to a cellular telephone device housing said noise-cancelling electronic processing means.

29. The earphone according to claim 26, wherein the module comprises a microspeaker and a microphone whose combined performance has been graded in accordance with a predetermined classification criterion, and wherein at least one component of said noise cancelling electronic processing means is adjusted during manufacture and permanently set to take account of the performance grading of the said microspeaker and microphone.

30. The earphone according to claim 26, wherein the housing for the noise-cancelling electronic processing means further houses user-adjustable means for adjusting to choice the earphone's noise-cancelling performance.

31. A method of producing ambient noise-cancelling earphones, comprising the steps of:
providing a module comprising a substrate supporting a microphone, a microspeaker and an acoustic resistor for controlling the acoustic properties of the earphone;
feeding known electrical signals to said microspeaker and deriving response signals from said microphone;
utilizing said known signals and said response signals to classify the combined performance of said microspeaker and microphone into grades indicative of a departure of said combined performance from one or more predetermined performance criteria;
providing information indicative of said grading;
providing separately from the earphone a housing to contain noise-cancelling electronic processing means;
utilizing said information to adjust and permanently set at least one component of said noise-cancelling electronic processing means to take account of the combined performance grading of the said microspeaker and microphone;
providing an information storage means on said module;
storing said information indicative of said grading in said information storage means;
causing said information storage means to provide said information upon interrogation; and
utilizing said provided information to compensate for said departure of said combined performance from one or more predetermined performance criteria.

32. The method according to claim 31, further comprising the steps of:
providing apparatus comprising first and second cavity-defining members;
disposing said module in said apparatus such that a forward-emitting surface of said microspeaker faces into a cavity defined by said first cavity-defining member and such that said microphone and a rearward-emitting surface of said microspeaker are disposed in a cavity defined by said second cavity-defining member;
disposing said cavity-defining members in face-to-face relationship; and
sealing acoustically said cavity-defining members together in said face-to-face relationship, whereby said microphone and said microspeaker can be classified into grades.
